(19) United States
(12) Patent Application Publication
(10) Pub. No.: US 2004/0199693 A1
(43) Pub. Date: Oct. 7, 2004

(54) METHOD FOR ACCESSING A MEMORY HAVING A STORAGE SPACE LARGER THAN THE ADDRESSING CAPABILITY OF A MICROPROCESSOR

(76) Inventors: Pao-Ching Tseng, Taipei City (TW); Ping-Cheng Sung, Hsin-Chu City (TW); Ping-Sheng Chen, Chia-Yi Hsien (TW); Li-Chun Tu, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/604,381

(22) Filed: Jul. 16, 2003

(30) Foreign Application Priority Data
Mar. 14, 2003 (TW) 092105701

(51) Int. Cl. G06F 12/00; G06F 13/24

(52) U.S. Cl. 710/260

(57) ABSTRACT

A method for accessing a memory having a storage space larger than the addressing capability of a microprocessor. The method comprises storing an interrupt service routine in one of a plurality of memory banks, when an interrupt occurs, pushing a current program counter address onto a stack by an interrupt processing unit, and pushing a bank number of the current memory bank onto the stack. The method further comprises switching the microprocessor to the memory bank storing the interrupt service routine to execute the interrupt service routine, popping the bank number of the memory bank from the stack, restoring the popped bank number in the memory bank selector, popping the program counter address from the stack, and continuing executing the interrupted program.

### BACKGROUND OF INVENTION

1. Field of the Invention

The invention relates to a method for accessing a memory and more particularly, to a method for accessing an external memory connected to a microprocessor.

2. Description of the Prior Art

Intel Corporation generally refers to a microprocessor as an MCS (Micro Computer System) and the MCS-51/52 series microprocessor developed by the Intel Corporation is commonly used in industry. Generally speaking, a microprocessor comprises a small memory and a few I/O ports.

Take the MCS-51 microprocessor for example; it comprises a program memory of 4K bytes, a data memory of 128 bytes, and 32 I/O ports. The MCS-52 series microprocessor comprises a program memory of 8K bytes and a data memory of 256 bytes. The MCS-51/52 series of microprocessors features an 8-bit CPU. The program memory is a read-only memory (ROM) for storing a program written by a user. The data memory is a random-access memory for storing data temporarily while the CPU executes a program. The capacity of the memory of the MCS-51/52 series microprocessor can be externally expanded to 64K bytes.

An external memory with capacity of 64K bytes is still not large enough if the user needs to write lengthy code or use a large array table. To solve this problem, the capacity of the external memory of the microprocessor can be substantially expanded by switching a plurality of memory banks when the user uses the extra pins of the micropro- cessor as decode lines to set an address for an external memory with capacity of over 64K bytes. If the external memory is one memory device with large capacity, the extra pins of the microprocessor can be address lines. If thereare several external memory devices with smaller capacity, the extra pins of the microprocessor can be used to select the memory chips. Because the largest capacity of the external memory of the microprocessor is 64K bytes, 64k bytes can be taken as a unit (a page) when the microprocessor switches the memory banks. Further, an interrupt vector table is usually stored at a specific address of the external memory, and the microprocessor searches for the interrupt vector table at the specific address in a current page immediately when an interruption of a working program occurs. Because the microprocessor cannot switch the plurality of memory banks when the interrupt occurs, an error comes up when the microprocessor cannot find the interrupt vector table in the current page. To solve this problem, a common area in each memory bank is reserved for storing the interrupt vector table, an interrupt service routine, general functions, and a memory bank switching routine, etc. This ensures that the microprocessor can find the interrupt vector table in the current page (can be any page) and, when the interrupt is finished, continue executing the interrupted program.

FIG. 1 is a diagram of an external memory 12 according to the prior art. The capacity of the external memory 12 of the MCS-51/52 series microprocessor is expanded to 512K bytes by switching the plurality of memory banks.The external memory 12 is divided into 8 pages. The capacity of each page is 64K bytes but a common area in each page with certain capacity (ex. 10K bytes)is reserved for storing the interrupt vector table, the interrupt service routine, the general functions, and the memory bank switching routine, etc. For example, when the microprocessor has to execute a program B in page 2 while executing a program A in page 1, it will call the bank switching routine in the common area. The memory bank switching routine stored in the common area will set the page number to 2, then the microprocessor can access the program Bin page 2. After executing the program in the page 2, the microprocessor will return to the program A by calling the bank switching routine in the common area, and the memory bank switching routine will switch the page number from 2 to 1, so the microprocessor can return to the address of the program A in page 1 to continue executing the program A.

According to the foregoing description, though the largest capacity of the external memory of the MCS-51/52 series microprocessor is 64K bytes, the external memory can be further expanded by switching the plurality of memory banks when using the extra pins of the microprocessor as the decode lines to set the address of the external memory with capacity of over 64K bytes. However, each memory bank has to reserve a certain space for the common area to store the interrupt vector table, the interrupt service routine, the general functions, and the memory bank switching routine, etc. These multiple sets of common area mean the space of the external memory is not used efficiently.

### SUMMARY OF INVENTION

It is therefore a primary objective of the claimed invention to provide a method for accessing an external memory connected to a microprocessor to solve the above-mentioned problems.

According to the claimed invention, the method for accessing the external memory that comprises a plurality of memory banks. Wherein the storage space of each memory bank equates to the largest addressing capability of the microprocessor. Further, the microprocessor comprises an interrupt processing unit and a memory bank selector for selecting the memory banks. The method comprises: (a) storing an interrupt service routine in one of the memory banks; (b) when an interrupt occurs, pushing a current program counter address onto a stack by the interrupt processing unit, pushing a bank number of the current memory bank onto the stack, and setting the memory bank selector to the bank number of the memory bank storing the interrupt service routine; (c) switching the microprocessor to the memory bank storing the interrupt service routine to execute the interrupt service routine; (d) popping the bank number of the memory bank stored in the stack in step (b) from the stack by the interrupt processor unit, restoring the popped bank number in the memory bank selector, and popping the program counter address stored in the stack in step (b) from the stack; and (e) after performing step (d), switching the microprocessor back to the memory bank corresponding to the bank number stored in the memory bank selector to continue executing the program interrupted in step (b).

These and other objectives of the present invention will no doubt obvious to those of ordinary skill in the art after reading the following detailed description of the preferred embodiment that is illustrated in the various figures and drawings.

### BRIEF DESCRIPTION OF DRAWINGS

FIG. 1 is a diagram of an external program memory according to the prior art.

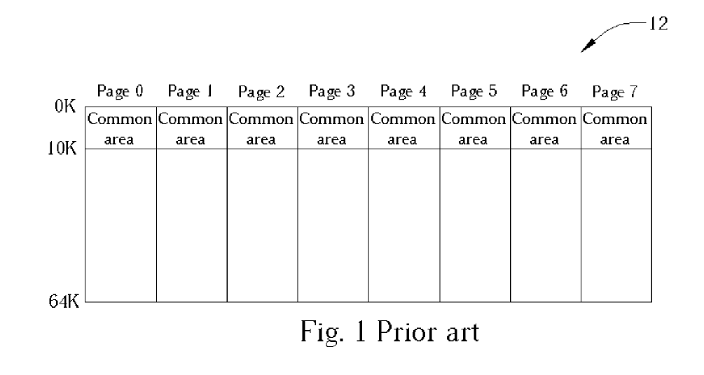

FIG. 2 is a diagram of the arrangement of a plurality of memory banks in an external program memory according to the present invention.

FIG. 3 is a flow chart of how to switch between the memory banks of FIG. 2 when an interrupt occurs.

FIG. 4 is a diagram of the stack specified in FIG. 3 when switching between the memory banks of FIG. 2.

### DETAILED DESCRIPTION

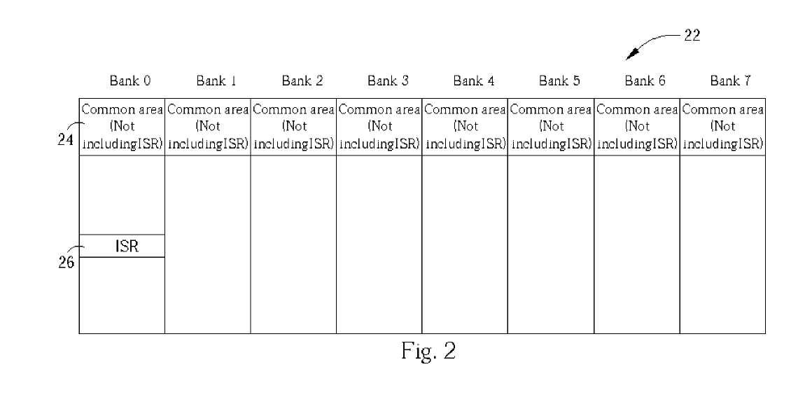

FIG. 2 is a diagram of the arrangement of a plurality of memory banks in an external program memory 22 according to the present invention. As previously described, the prior art stores multiple sets of common area and therefore the space of the external memory is not used efficiently. To decrease the space occupied by the common area, the present invention omits the interrupt service routine from each common area 24 in each memory bank and instead stores the interrupt service routine 26 in one of the memory banks in the external program memory 22.When an interrupt occurs, a microprocessor switches to the memory bank storing the interrupt service routine 26 to access the interrupt service routine 26.

Because the space occupied by the common area in each memory bank is reduced, the storage space of each memory bank becomes larger and the memory banks will be switched less frequently. For example, FIG. 2 shows the external memory 22 is comprised of 8 banks. The capacity of each bank is 64K bytes but a common area in each bank with capacity of 10K bytes is reserved. Assume the total size of the interrupt service routines is 4K bytes. Then if the common areas do not store the interrupt service routines and instead only bank 0 of the memory bank stores the interrupt service routines 26, the effective capacity of each memory bank (except bank 0) is increased from 54K bytes to 58K bytes and the total increased capacity is 28K (4K*(8−1)=28K).

When an interrupt occurs, a CPU of the microprocessor pushes a current program counter address and a bank number of the current memory bank onto a stack in that order, and then switches the working memory bank to bank 0 of the external memory 22 to execute the interrupt service routine. When finished executing the interrupt service routine, the CPU pops the bank number of the memory bank and the program counter address from the stack in that order, and switches the microprocessor back to the memory bank and continue executing the interrupted program.

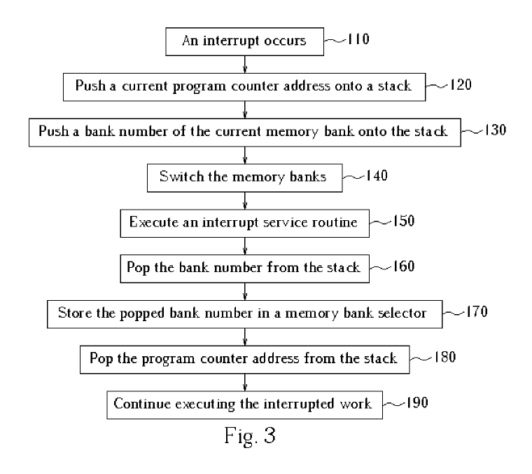

FIG. 3 is a flow chart of how to switch the memory banks when an interrupt occurs according to the present invention. Because the common areas of the memory banks donot comprise the interrupt service routine, when the interrupt occurs, the CPU of the microprocessor pushes the working program counter address and the bank number of the working memory bank onto the stack. Therefore, after the microprocessor switches the memory bank to the bank storing the interrupt service routine and finishes executing the interrupt service routine, it can be switched back to the address interrupted according to the data stored in the stack. According to the present invention, the detail procedure of switching the memory banks after the interrupt occurs is described below:

Step 110: When an interrupt occurs, the CPU receives the request to execute the interrupt service routine.

Step 120: Push the working program counter address onto the stack. First, push the current program counter 8-bit low address onto the stack, and then push the current program counter 8-bit high address onto the stack.

Step 130: Push the bank number of the working memory bank, which is the 8-bit data word of a memory bank selector that stores the bank number, onto the stack.

Step 140: Set the memory bank selector to the bank number of the memory bank storing the interrupt service routine so that the CPU can switch the microprocessor to the memory bank storing the interrupt service routine to execute the interrupt service routine.

Step 150: Execute the interrupt service routine.

Step 160: Pop the bank number of the memory bank from the stack.

Step 170: Store the popped bank number in step 160 in the memory bank selector.

Step 180: Pop the program counter address from the stack. First, pop the program counter 8-bit high address from the stack, and then pop the program counter 8-bit low address from the stack.

Step 190: Continue executing the interrupted program.

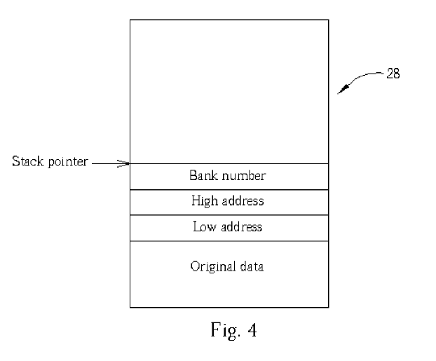

FIG. 4 is a diagram of how to use the stack 28 when switching memory banks according to the present invention. The stack 28 of the microprocessor uses a stack pointer to point to a position of a memory in the microprocessor, representing the next position of the stack 28. Generally, the stack 28 is used to store a program counter for the return address or data set by a user. Assume the microprocessor executes an 8-bit command set, each data stored in the stack 28 will be 8-bits long. The last data pushed onto the stack 28 is the first data to be popped from the stack. According to the procedure previously described, when an interrupt occurs, the CPU will first use the stack 28 to store the current program counter address. After performing step 130, the data pushed onto the stack 28 will be as shown in FIG. 4. When executing the interrupt service routine in step 150, the stack 28 may be used to store some parameters. However, when the interrupt service routine is finished executing, the data stored in the stack 28 will still be shown as FIG. 4. Therefore, the CPU can use the data pushed onto the stack 28 to perform step 160 to step 190 so that the CPU can return to the original place to continue executing the interrupted program.

In contrast to the prior art, the present invention provides the method of pushing the current bank number onto the stack 28 for the CPU of the microprocessor when an interrupt occurs, so the interrupt service routine can be omitted from the common area of each memory bank to decrease the space occupied by the common area. Therefore, the effective storage space of each memory bank is increased, thus, the memory banks will be switched less frequently and the CPU accesses the external memory more efficiently. The prior art has to reserve a certain space in each memory bank for the common area comprising the interrupt service routine when expending the capacity of the external memory by switching the memory banks. These multiple copies of the interrupt service routine mean the space of the external memory is not used efficiently. Compared with the prior art, the present invention uses the storage space of the external memory more efficiently.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method for accessing a memory having a storage space larger than the addressing capability of a microprocessor, the memory comprising a plurality of memory banks, the microprocessor comprising a stack, an interrupt processing unit, and a memory bank selector for selecting the memory banks, the method comprising:
(a) storing an interrupt service routine in one of the memory banks;
(b) when an interrupt occurs, pushing a current program counter address onto the stack by the interrupt processing unit, pushing a bank number of the current memory bank onto the stack, and setting the memory bank selector to the bank number of the memory bank storing the interrupt service routine;
(c) switching the microprocessor to the memory bank storing the interrupt service routine to execute the interrupt service routine;
(d) after interrupt service routine finishes execution, popping the bank number of the memory bank stored in the stack in step (b) from the stack by the interrupt processor unit, restoring the popped bank number to the memory bank selector, and popping the program counter address stored in the stack in step (b) from the stack; and
(e) switching the microprocessor back to the memory bank corresponding to the bank number stored in the memory bank selector to continue executing the program interrupted in step (b).

2. The method of claim 1 wherein the microprocessor is a MCS series microprocessor.

3. The method of claim 1 wherein the method further comprises storing a common area in each memory bank.

4. The method of claim 3 wherein the common area does not comprise the interrupt service routine.

5. A single chip microprocessor for executing the method of claim 1.
